(19) United States
(12) Patent Application Publication
(10) Pub. No.: US 2007/0135076 A1
(43) Pub. Date: Jun. 14, 2007

(54) Wideband mixer with multi-standard input

(75) Inventors: Alan R. Holden, McKinney, TX (US); Jason P. Jaehnig, Dallas, TX (US)

Correspondence Address: BORDEN LADNER GERVAIS LLP, 1100-100 QUEEN ST, OTTAWA, ON, K1P 1J9, CA

(73) Assignee: SiRiFIC WIRELESS CORPORATION

(21) Appl. No.: 11/297,335

(22) Filed: Dec. 9, 2005

(51) Int. Cl. H04B 1/26

(52) U.S. Cl. 455/326

(57) ABSTRACT

A wideband mixer circuit that is flexible and reconfigurable so that several identical wideband mixer circuits may be used in lieu of several fixed narrow-band mixers. Such wideband mixer circuits can be provided in multiples within a chip such that multiple inputs are each within a wide frequency range (i.e., 3 GHz) and may be actively narrowed to any desired frequency range by way of the operation inherent to the circuit architecture. Such a chip supports multiple standards at each input.

### FIELD OF THE INVENTION

The invention relates to a mixing circuit that serves in general for multi-standard, multi-band direct conversion radio transceivers.

### BACKGROUND OF THE INVENTION

Chipsets used in current wireless communication typically utilize standard-specific circuitry. Such circuitry must cope with the wireless communication market's steadily increasing demand for wireless data services in applications including mobile handsets, laptops, and PDAs (personal digital assistants). Industry predictions include projections that soon over half of the mobile handsets sold will have an integrated digital camera, 98% of notebooks sold will have WLAN (wireless local area network) 802.11 capability, and there will be over 30 million frequent users of public WLAN hot spots. The result of this will be increased consumer reliance on wireless data for connectivity and data transfer for such diverse wireless applications.

The diversity in burgeoning wireless applications includes a corresponding diversity in the delivery medium for such wireless data. Such delivery medium and related standards will likely include both existing and future technologies including WLAN, GSM (global system for mobile communications), WCDMA (wideband code division multiple access), GPRS (general packet radio service), EDGE (enhanced data for global evolution) along with variations and hybrid technologies in the form of various technology generations—i.e., 2.5 G, 2.75 G, 3 G, 4 G, and beyond.

In parallel, this wireless market demand is driving high performance wireless semiconductors that combine multiple bands and standards into a single chip. Chipsets used in current wireless communication, such as for WCDMA or GSM technology, typically utilize standard-specific mixing circuitry. In order to satisfy multiple wireless applications and related standards, one chip commonly includes two or more narrow band mixers that would each operate within a narrow frequency range—e.g., 100 MHz. For example, the GSM standard includes modes operating at 900 MHz and 1,900 MHz.

Each narrow-band mixer input on such a GSM chip would therefore be designed to separately operate at 900 MHz and 1900 MHz with each mixer having a bandwidth of 100 MHz. A typical such mixer 100 is illustrated in FIG. 1 having a pair of transistors 110, 120 and mixing cell (i.e., quad) that are optimized for the given operating frequency and resistances 111, 121 that are typically fixed in the form of the bond wire connecting such mixer 100 at the circuit board level. As well, the existing interface of such a GSM chip are fixed such that other circuit modules connected to such GSM chips must adhere to the same interface arrangement—i.e., 900 MHz output of an additional circuit module would be connectable only to the 900 MHz mixer input of the GSM chip. If such matching physical interfaces do not exist or evolve with migration of any given standard, connections between with such chips can become costly in terms of layout design and resultant noise generated by complicated connection patterns.

FIG. 1A illustrates a typical arrangement where a known type of multi-frequency component 110 (e.g., a bank of filters) includes, for example, 800 MHz, 1800 MHz, and 1900 MHz outputs connected to multi-frequency inputs of a known mixer structure 120. Though not shown, it should of course be understood that capacitors or any other physical component may be arranged within the physical connection path between the multi-frequency component and the known mixer structure. Such known mixer structure 120 includes dedicated mixer inputs that are physically configured in a fixed manner to accept a corresponding 800 MHz, 1800 MHz, and 1900 MHz input. Ideally, the connection made between the multi-frequency component 110 and the known mixer structure 120 is a straight physical connection. However, the pin arrangement on any given multi-frequency component 110 may vary. While the pin arrangement on the known mixer structure 120 may be re-designed and re-manufactured to maintain a straight physical connection with any respective other type of multi-frequency component, this is a costly approach. More often, such re-design and re-manufacture are avoided by routing the connections in a less than straight physical connection as illustrated generally by way of FIG. 1B.

Within the arrangement illustrated by FIG. 1B, it should be readily apparent to one of ordinary skill in the art that various detrimental effects occur as an outcome of routing the connections in a less than straight physical connection. FIG. 1B illustrates a typical arrangement where a different known type of multi-frequency component 111 includes, for example, 800 MHz, 1800 MHz, and 1900 MHz outputs connected to multi-frequency inputs of a known mixer structure 120 Here, a variety of inductances, capacitances, and/or resistances created by physical characteristics (layering and vias) of a less than straight physical connection can introduce significant losses due to noise and the like. Accordingly, avoiding re-design and re-manufacture of any known mixer structure by routing the connections in a less than straight physical connection is not an optimal solution. Moreover, any chip with fixed inputs each having a narrow band mixer specifically fixed for each frequency range for a given wireless technology is disadvantageous for several reasons including increased manufacturing costs, reduced flexibility for changing standards and correspondingly varied operating frequency ranges, and reduced compatibility of board level pin arrangements.

### SUMMARY OF THE INVENTION

The object of the invention is to remedy the drawbacks set out above by proposing a wideband mixing circuit that serves in particular for multi-standard, multi-band direct conversion radio transceivers.

To this end, the invention provides a wideband mixing circuit including a first circuit portion for setting input impedance of the wideband mixing circuit, the first circuit portion located between a differential input and a differential output; a second circuit portion for linearizing the wideband mixing circuit; and a pair of transistors connected between the first circuit portion and the second circuit portion.

In another embodiment, the invention provides an integrated circuit package for multi-standard, multi-band direct conversion radio transceivers, the package including multiple mixing circuits for operation within a 3 GHz frequency range; each mixing circuit including at least, a first circuit portion for setting input impedance of the mixing circuit, the first circuit portion located between a differential input and a differential output, a second circuit portion for linearizing the mixing circuit, and a pair of transistors connected between the first circuit portion and the second circuit portion.

In still another embodiment, the invention provides a multi-standard, multi-band direct conversion apparatus for radio transceivers, the apparatus including a first mixing circuit for reconfigurable operation within a desired frequency range for receiving a first input signal having a first frequency, and a second mixing circuit for reconfigurable operation within the desired frequency range for receiving a second input signal having a second frequency, the first mixing circuit being reconfigurable to receive the second input signal and the second mixing circuit being reconfigurable to receive the first input signal. Each of the first and second mixing circuits can include at least a first circuit portion for setting input impedance of the mixing circuit, the first circuit portion located between a differential input and a differential output, a second circuit portion for linearizing the mixing circuit, and a pair of transistors connected between the first circuit portion and the second circuit portion. The first mixing circuit provides a first output signal and the second mixing circuit provides a second output signal, where the first output signal and the second output signal can be selectively passed by a multiplexor circuit.

### BRIEF DESCRIPTION OF THE DRAWINGS

FIG. 1 is a simplified schematic of a typical mixer input.

FIGS. 1A and 1B are two examples of generalized illustrations of typical mixer and component arrangements.

FIG. 2 is a graph illustrating the effect of a capacitor within a linearizing portion of the mixing circuit of the present invention.

FIG. 3 is a simplified schematic of a wideband mixing circuit in accordance with the present invention.

FIG. 3A is a generalized illustration of a mixer and component arrangement incorporating the wideband mixing circuit in accordance with the present invention.

FIG. 3B is a generalized illustration of a mixer and component arrangement incorporating the wideband mixing circuit in accordance with another embodiment of the present invention.

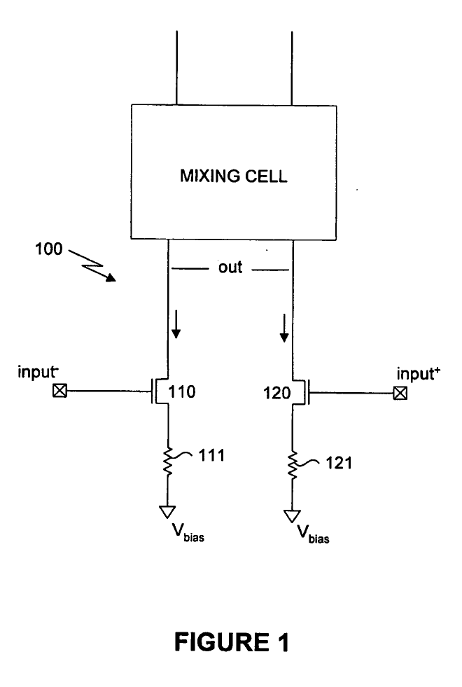

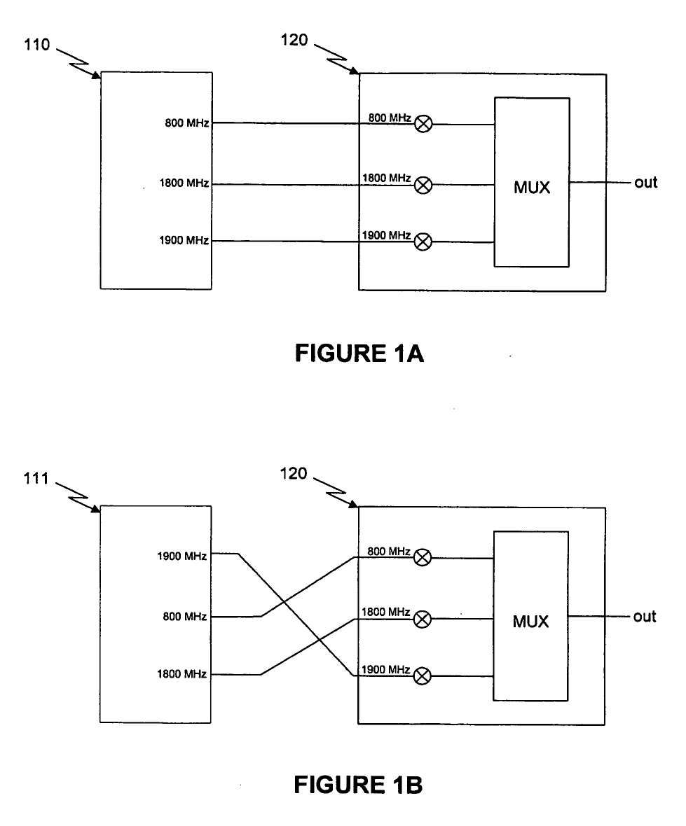

### DETAILED DESCRIPTION

The present invention includes a wideband mixer circuit that is flexible so that several identical wideband mixer circuits may be used in lieu of several fixed narrow-band mixers. Such wideband mixer circuits would therefore be provided in multiples within a chip such that multiple inputs are each within a wide frequency range (i.e., 3 GHz) and may be actively narrowed to any desired frequency range by way of the operation inherent to the circuit architecture. Such a chip therefore supports multiple standards at each input. This provides flexibility in that such chips would not need to be designed for any specific standard with a requisite frequency range. Moreover, from a system level perspective, such chips would avoid re-design and re-manufacture as well as avoid less than straight physical connections when applied to any given multi-frequency component.

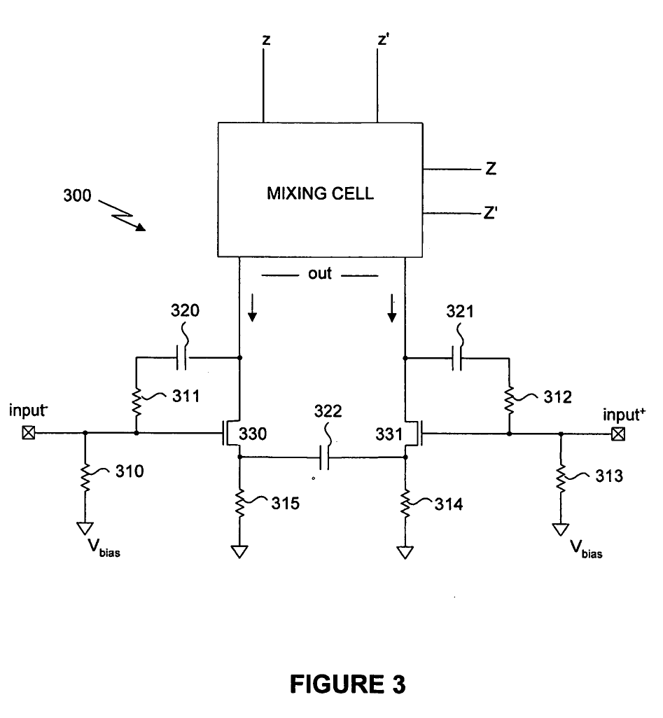

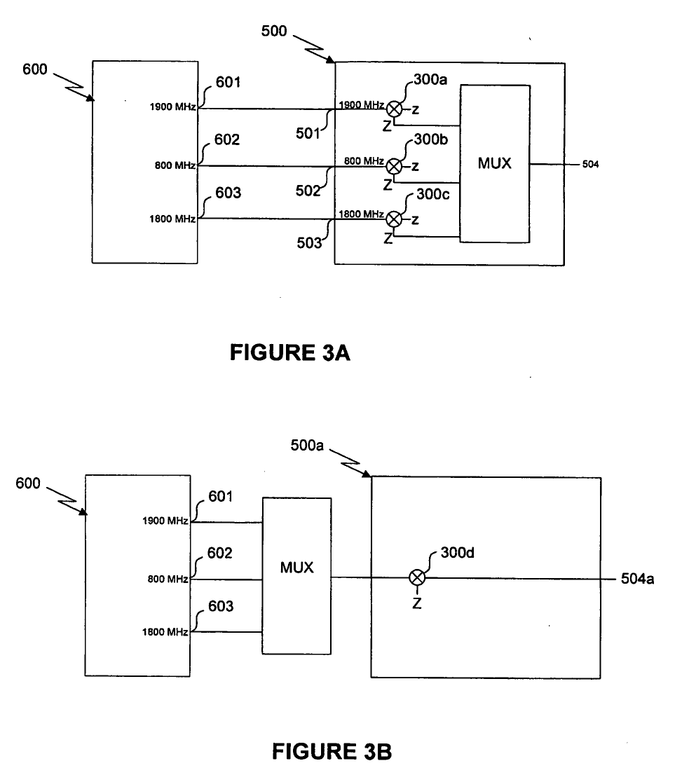

FIG. 3 is a simplified diagram that illustrates a wideband mixer circuit 300 in accordance with the present invention. The wideband mixer circuit 300 includes differential inputs biased through resistors 310, 313 and operates to convert differential voltage into differential current and provide such current to the given device (not shown) internal to the chip incorporating the wideband mixer circuit 300. This wideband mixer circuit 300 operates within a frequency range that is much greater than typical input mixer circuitry. When a signal anywhere within the extended range of 3 GHz comes into the wideband mixer circuit 300, the signal is transferred to the current output.

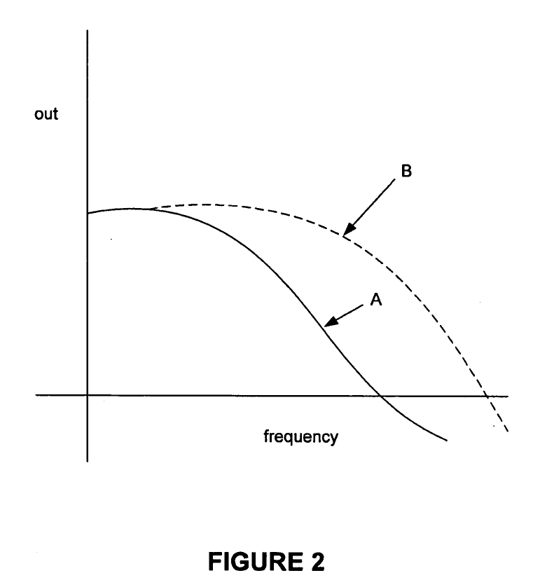

The input impedance of the wideband mixer circuit 300 is set by the two RC branches each formed by resistor 311 in series with capacitor 320 and by resistor 312 in series with capacitor 321. A linearizing branch is formed by resistors 314, 315 and capacitor 322 and serves to linearize the output of the circuit 300. Resistors 314, 315 reduce the overall gain of the circuit 300 at low frequency. The capacitor 322 effectively extends the operating bandwidth of the circuit 300. This aspect is shown in FIG. 2 where the operating frequency at the output is illustrated as graph A without the capacitor 322 and illustrated as extended by the capacitor 322 as graph B. At high frequency, the capacitor 322 effectively shorts the two resistors 314, 315 together such that they increase the gain of the circuit. However, the overall frequency response of the circuit 300 will generally reduce the gain at high frequency and therefore compensate for the effective shorting of the two resistors 314, 315 at high frequency by the capacitor 322. In this way, operation is assured at either low (e.g., 900 MHz) or high frequencies (e.g., 1900 MHz).

Unlike within prior art mixer circuits, the transistors 330 and 331 of the present invention do not need to be optimized for the pre-specified operating frequency (e.g., 900 MHz and 1900 MHz as mentioned above in regard to GSM modes). Rather, the impedance setting RC branches (resistor 311 in series with capacitor 320 and resistor 312 in series with capacitor 321) combine with the linearizing branch (resistors 314, 315 and capacitor 322) to enable transistors 330 and 331 to operate within a frequency range of up to 3 GHz.

In practice, the wideband mixer circuit 300 of the present invention would be provided within an integrated circuit package (i.e., chip). This is illustrated by way of FIG. 3A that includes a wideband mixer chip 500 having three wideband mixer circuits 300a, 300b, 300c in accordance with the present invention. While three such mixer circuits 300a, 300b, 300c are shown, it should be understood that any number of such circuits may be utilized without straying from the intended scope of the present invention. Each such mixer circuit 300a, 300b, 300c is shown having respective inputs 501, 502, 503 each connected to an output 601, 602, 603 of a multi-frequency component 600. Due to the wideband capability of each such mixer circuit 300a, 300b, 300c, the frequencies from each output 601, 602, 603 do not need to correspond to the frequency acceptability of each input 501, 502, 503. Rather, the frequency acceptability of each input 501, 502, 503 is configurable to accept any frequency within the inventive mixer circuit's wideband range (e.g., 900 MHz to 1900 MHz).

As an alternative embodiment, the MUX may reside off-chip relative to the wideband mixer chip 500a as shown in FIG. 3B. In such instance, only one mixing circuit 300d would be necessary for the mixer chip 500a.

The wideband mixer chip 500 in accordance with the present invention would effectively constitute a reconfigurable mixer chip because each mixer circuit 300a, 300b, 300c is a wideband mixer as discussed above in regard to FIG. 3. Specifically, each mixer circuit 300a, 300b, 300c would receive a different mixing cell input Z that corresponds to driving each mixing circuit 300a, 300b, 300c to a desired operating frequency. In this manner, it is anticipated that only one mixing circuit operates at a time whereby the multiplexer MUX switches the appropriate signal path and associated mixer circuit 300a, 300b, 300c to an output 504 of the wideband mixer chip 500 to the given device (not shown).

Within such a wideband mixer chip, the wideband mixer circuit 300 can be easily duplicated to provide multiple inputs for differing signals operating at various frequencies. In this manner, a single package may be easily manufactured using a standardized design that does not require dedicating specific inputs for specific operating frequencies. A beneficial reduction in manufacturing costs and ubiquity of the given chip would therefore result.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A multi-standard, multi-band direct conversion apparatus for radio transceivers, said apparatus comprising:
a first mixing circuit for reconfigurable operation within a desired frequency range for receiving a first input signal having a first frequency; and,
a second mixing circuit for reconfigurable operation within the desired frequency range for receiving a second input signal having a second frequency, the first mixing circuit being reconfigurable to receive the second input signal and the second mixing circuit being reconfigurable to receive the first input signal.

2. The multi-standard, multi-band direct conversion apparatus of claim 1, wherein each of the first mixing circuit and the second mixing circuit includes at least,
a first circuit portion for setting input impedance of said mixing circuit, said first circuit portion located between a differential input and a differential output,
a second circuit portion for linearizing said mixing circuit, and
a pair of transistors connected between said first circuit portion and said second circuit portion.

3. The multi-standard, multi-band direct conversion apparatus of claim 1, wherein the first mixing circuit provides a first output signal and the second mixing circuit provides a second output signal, the first output signal and the second output signal being selectively passed by a multiplexor circuit.

4. A wideband mixing circuit comprising:
a first circuit portion for setting input impedance of said wideband mixing circuit, said first circuit portion located between a differential input and a differential output;
a second circuit portion for linearizing said wideband mixing circuit; and
a pair of transistors connected between said first circuit portion and said second circuit portion.

5. The wideband mixing circuit of claim 4, wherein said pair of transistors are operable within a frequency range of 3 GHz.

6. The wideband mixing of claim 5, wherein said first circuit portion is formed by a first capacitor in series with a first resistor and a second capacitor in series with a second resistor, said first capacitor being connected to the drain of a first one of said pair of transistors and said first resistor being connected to the gate of said first one of said pair of transistors, said second capacitor being connected to the drain of a second one of said pair of transistors and said second resistor being connected to the gate of said second one of said pair of transistors.

7. The wideband mixing circuit of claim 6, wherein said second circuit portion is formed by a capacitor connected between the source of said first one of said pair of transistors and the source of said second one of said pair of transistors, a third resistor connected to the source of said first one of said pair of transistors, and a fourth resistor connected to the source of said second one of said pair of transistors.

8. An integrated circuit package for multi-standard, multi-band direct conversion radio transceivers, said package comprising:
multiple mixing circuits for operation within a 3 GHz frequency range;
each said mixing circuit including at least,
a first circuit portion for setting input impedance of said mixing circuit, said first circuit portion located between a differential input and a differential output,
a second circuit portion for linearizing said mixing circuit, and
a pair of transistors connected between said first circuit portion and said second circuit portion.

9. The package of claim 8, wherein said first circuit portion is formed by a first capacitor in series with a first resistor and a second capacitor in series with a second resistor, said first capacitor being connected to the drain of a first one of said pair of transistors and said first resistor being connected to the gate of said first one of said pair of transistors, said second capacitor being connected to the drain of a second one of said pair of transistors and said second resistor being connected to the gate of said second one of said pair of transistors.

10. The package of claim 9, wherein said second circuit portion is formed by a capacitor connected between the source of said first one of said pair of transistors and the source of said second one of said pair of transistors, a third resistor connected to the source of said first one of said pair of transistors, and a fourth resistor connected to the source of said second one of said pair of transistors.
